(19) United States
(12) Patent Application Publication
(10) Pub. No.: US 2024/0004045 A1
(43) Pub. Date: Jan. 4, 2024

(54) Mitigation of phase noise due to back-scatter in coherent optical sensing

(71) Applicant: APPLE INC., Cupertino, CA (US)

(72) Inventors: Rami Shnaiderman, Munich (DE); Ariel Lipson, Tel Aviv (IL); Artiom Sydnev, Atlit (IL)

(21) Appl. No.: 18/314,843

(22) Filed: May 10, 2023

Related U.S. Application Data
(60) Provisional application No. 63/357,010, filed on Jun. 30, 2022.

(51) Int. Cl. G01S 7/493; G01S 7/4912; G01S 17/58

(52) U.S. Cl. CPC G01S 7/493; G01S 17/58; G01S 7/4917

(57) ABSTRACT

An optical sensing device includes an optical transmitter, coupled to transmit outgoing modulated radiation from a coherent radiation source at a predefined wavelength toward a target. A splitter splits off a fraction of the outgoing modulated radiation. An optical element is disposed in a path of the outgoing modulated radiation following the splitter. A mixer mixes the fraction of the outgoing modulated radiation with incoming radiation, including the modulated radiation that has been reflected from the target via the optical element. An optical delay line conveys the fraction of the outgoing modulated radiation from the splitter to the mixer over a first optical length that is within one wave, at the predefined wavelength, of a second optical length from the splitter to the mixer of a portion of the modulated radiation that is scattered from the optical element into the mixer. A photodetector receives the mixed radiation from the mixer.

### CROSS-REFERENCE TO RELATED APPLICATION

This application claims the benefit of U.S. Provisional Patent Application 63/357,010, filed Jun. 30, 2022, which is incorporated herein by reference.

### FIELD OF THE INVENTION

The present invention relates generally to systems and methods for optical sensing, and particularly to coherent sensing.

### BACKGROUND

In certain frequency-modulated coherent sensing arrangements, a radiofrequency (RF) chirp is applied to modulate the frequency of a beam of coherent light (typically a monochromatic single-mode laser beam) that is directed toward a target. The light reflected from the target is mixed with a sample of the transmitted light (referred to as the local beam or local oscillator (LO)) and detected by a photodetector, such as a balanced photodiode pair. The photodetector outputs a signal at a beat frequency that is proportional to the range of the target.

When the target is moving, the resulting Doppler shift of the reflected light will cause the beat frequency to increase or decrease, depending on the direction of motion. By comparing the beat frequencies obtained from chirps of positive and negative slopes, it is thus possible to extract both the range and the velocity of the target. In the ideal case, if the beat frequency due to the Doppler shift is d, and the beat frequency due to the chirp and range is r, then the measured beat frequency for the up-chirp will be fᵤ=d+r, and the beat frequency on the down-chirp will be f_{d}=d−r. Thus, the sum of the measured up and down chirp frequencies reveals the Doppler shift, and the difference the range.

### SUMMARY

Embodiments of the present invention that are described hereinbelow provide improved methods and devices for coherent sensing.

There is therefore provided, in accordance with an embodiment of the invention, an optical sensing device, including an optical transmitter, coupled to transmit outgoing modulated radiation from a coherent radiation source at a predefined wavelength toward a target. A splitter is coupled to split off a fraction of the outgoing modulated radiation. An optical element is disposed in a path of the outgoing modulated radiation following the splitter. A mixer is coupled to mix the fraction of the outgoing modulated radiation with incoming radiation, including the modulated radiation that has been reflected from the target via the optical element. An optical delay line is configured to convey the fraction of the outgoing modulated radiation from the splitter to the mixer over a first optical length that is within one wave, at the predefined wavelength, of a second optical length from the splitter to the mixer of a portion of the modulated radiation that is scattered from the optical element into the mixer. A photodetector is coupled to receive the mixed radiation from the mixer.

In one embodiment, the first optical length differs from the second optical length by one half wave at the predefined wavelength. Alternatively, the first optical length is equal to the second optical length at the predefined wavelength.

In some embodiments, the optical transmitter includes a transmit waveguide coupled between the splitter and the optical element, and the device includes a receive waveguide, which is coupled to convey the incoming radiation from the optical element to the mixer, and the optical delay line includes a local waveguide coupled between the splitter and the mixer. In a disclosed embodiment, the device includes a planar substrate, wherein the transmit waveguide, the receive waveguide, and the local waveguide are disposed on the planar substrate in a photonic integrated circuit (PIC). In one embodiment, the local waveguide includes a semiconductor core and a cladding, having respective dimensions chosen so as to set the first optical length.

In one embodiment, the optical delay line is tunable so as to adjust the first optical length relative to the second optical length.

In some embodiments, the photodetector is configured to output a beat signal responsively to an instantaneous frequency difference between the outgoing modulated radiation and the incoming radiation received via the optical element. In a disclosed embodiment, the photodetector includes a balanced pair of photodiodes.

Additionally or alternatively, the device includes processing circuitry, which is configured to find a range and velocity of the target responsively to the beat signal.

There is also provided, in accordance with an embodiment of the invention, a method for optical sensing, which includes transmitting outgoing modulated radiation from a coherent radiation source at a predefined wavelength toward a target via an optical element. A fraction of the outgoing modulated radiation is split off at a location in a path of the outgoing modulated radiation between the coherent radiation source and the optical element. The fraction of the outgoing modulated radiation is conveyed from the location of the splitting to a mixer via an optical delay line over a first optical length that is within one wave, at the predefined wavelength, of a second optical length from the location to the mixer of a portion of the modulated radiation that is scattered from the optical element into the mixer. In the mixer, the fraction of the outgoing modulated radiation is mixed with incoming radiation, including the modulated radiation that has been reflected from the target via the optical element, and the mixed radiation is detected.

The present invention will be more fully understood from the following detailed description of the embodiments thereof, taken together with the drawings in which:

### BRIEF DESCRIPTION OF THE DRAWINGS

FIG. 1 is a schematic top view of an FMCW LiDAR system, in accordance with an embodiment of the invention;

FIG. 2 is a graph that schematically illustrates simulated beat signal spectra in the system of FIG. 1 for different levels of power of a back-reflected beam, in accordance with an embodiment of the invention; and

FIG. 3 is a schematic top view of an FMCW LiDAR system, in accordance with an alternative embodiment of the invention.

### DETAILED DESCRIPTION OF EMBODIMENTS

In an FMCW LiDAR, a coherent source of optical radiation, such as a continuous-wave (CW) laser, emits a beam of linearly chirped optical radiation, i.e., a beam whose frequency is modulated at a constant rate, typically using radiofrequency (RF) modulation. Using a splitter of optical radiation, such as a cube beamsplitter or a fiber splitter, the beam of optical radiation is divided into a transmit (Tx) beam and into a local oscillator (LO) beam. The Tx beam exits the LiDAR and is typically scanned by a scanner across a target whose range is to be measured by the LiDAR. The optical radiation reflected by the target, referred to as the receive (Rx) beam, is received by the LiDAR, and mixed with the LO beam using a mixer such as a beamsplitter or a directional coupler. The sum of the two beams is detected by a photodetector, for example a balanced pair of photodiodes.

The target is typically located at a distance from the LiDAR such that the combined propagation length of the Tx and Rx beams is much larger than the propagation length of the LO beam. Due to this difference in the paths of the two beams received by the photodetector and the chirp of the emitted optical radiation, the frequencies of the Rx beam and the LO beam at the photodetector are different, producing a beat signal. This beat signal is read from the photodetector by processing circuitry, which derives from the beat frequency of the signal both the range and the velocity of the target.

While the Tx beam propagates within the LiDAR, a portion of the beam may be scattered into the Rx beam. This portion, referred to herein as a back reflection (BR) beam, may originate from various optical elements in the LiDAR device, for example due to optical crosstalk between the Tx and Rx paths or reflections from optical surfaces. Thus, the BR beam propagates with the Rx beam to the photodetector. As the BR beam originates at a fixed distance that is much smaller than the range of the target, the beat frequency between the BR and LO beams at the photodetector is much smaller than the beat frequency between the Rx and LO beams. However, because the Rx beam is attenuated by the square of the range to the target, the BR beam can be much more powerful than the Rx beam, so that the beat spectrum is dominated by the BR beam. This, in turn, may lower the signal-to-noise ratio (SNR) of the beat signal indicating the range of the target, thus reducing the accuracy of determining the range.

The embodiments of the present invention that are described herein address this problem by introducing an optical delay line in the LO beam path, whose length is set to create an optical pathlength difference between the LO and BR beams that is within one wave at the predefined wavelength of the Tx beam. The term “wave” is used in the context of the present description and in the claims to mean a unit of length equal to the wavelength the light in question, meaning the wavelength of the Tx beam in the present case. The “predefined wavelength” of the Tx beam refers to the center wavelength of the narrow emission band of the coherent light source that generates the Tx beam, which is then transmitted toward the target.

In some embodiments, the optical pathlengths of the LO and BR beams are equalized, so that the spectrum of the beat signal between the two beams has a frequency of zero (DC signal), decaying for frequencies larger than zero. This solution is particularly effective for distant targets, which will give rise to high beat frequencies.

In some embodiments, the optical pathlength difference between the LO and BR beams is set to one half wave (λ/2) at the wavelength of the Tx beam. As a result, the LO and BR beams are in antiphase, and the sum of the two beams at the photodetector is zero. In this case, the above-described DC component in the beat spectrum is canceled, along with the low-frequency peak due to the BR beam. This reduces the effect of the BR beam on the SNR of the measured beat signal for any range of the target.

In some embodiments, the optical delay line is passive, such as a fiber optic line or a waveguide line. The optical length of the delay line is determined by its length and effective refractive index and may be tuned by changing one or more of the refractive indices or by changing its dimensions. The optical length of the optical delay line may be actively and continuously controlled by phase shifters based on such effects as, for example, thermal effects and carrier-injection effects. Alternatively, electro-optical modulators may be used.

In the disclosed embodiments, an optical sensing device comprises an optical transmitter, a splitter, an optical element, a mixer, an optical delay line, and a photodetector. The transmitter transmits outgoing modulated radiation (the Tx beam) from a coherent radiation source at a wavelength λ toward a target, with the splitter and the optical element located in the path of the outgoing radiation. The splitter splits off a fraction of the Tx beam into a local oscillator (LO) beam, with the remaining Tx beam projected through the optical element toward the target. A part of the Tx beam is reflected back from the target to the sensing device as a received (Rx) beam, and propagates within the device to the mixer. It is assumed that another part of the Tx beam is scattered (by reflection or other effects) from the optical element as a back-reflected (BR) beam, and propagates to the mixer together with the Rx beam. The LO beam propagates through the optical delay line into the mixer, where the LO beam is mixed with the Rx beam and the BR beam, and the mixed beams are conveyed to the photodetector.

The optical delay line is configured so that the optical length from the splitter to the mixer, along the path of the LO beam, is within one wavelength λ of the optical length from the splitter to the optical element and, along the path of the BR beam, to the mixer. As noted earlier, noise in the signal output by the photodetector is most effectively reduced when the optical pathlength difference between the LO and BR beams is zero or λ/2. Even when the optical pathlength difference is slightly detuned from these values, however, the noise may still be reduced substantially, thus resulting in a more accurate measurement of the actual beat frequency due to the target.

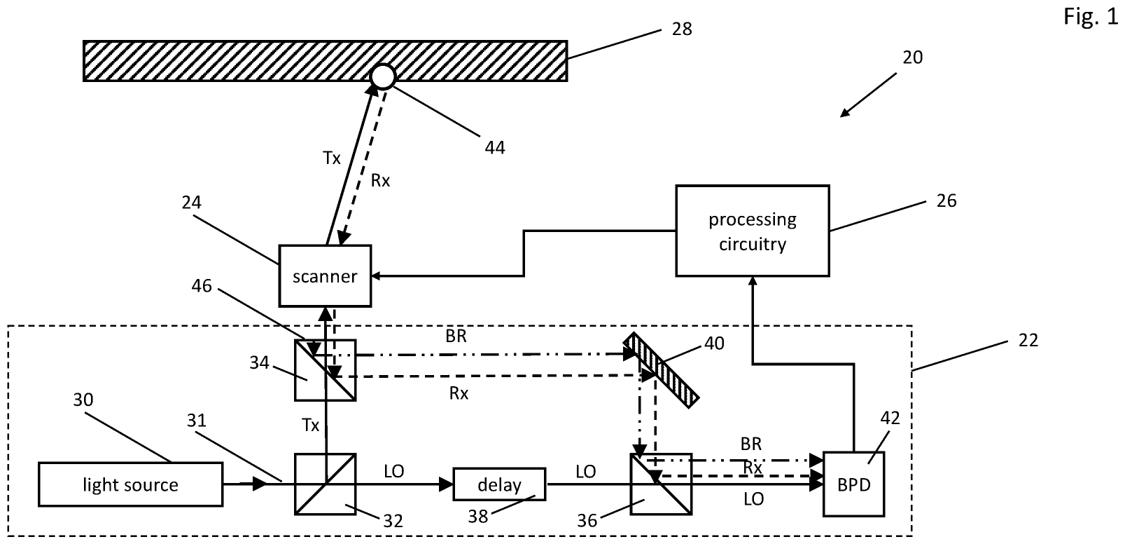

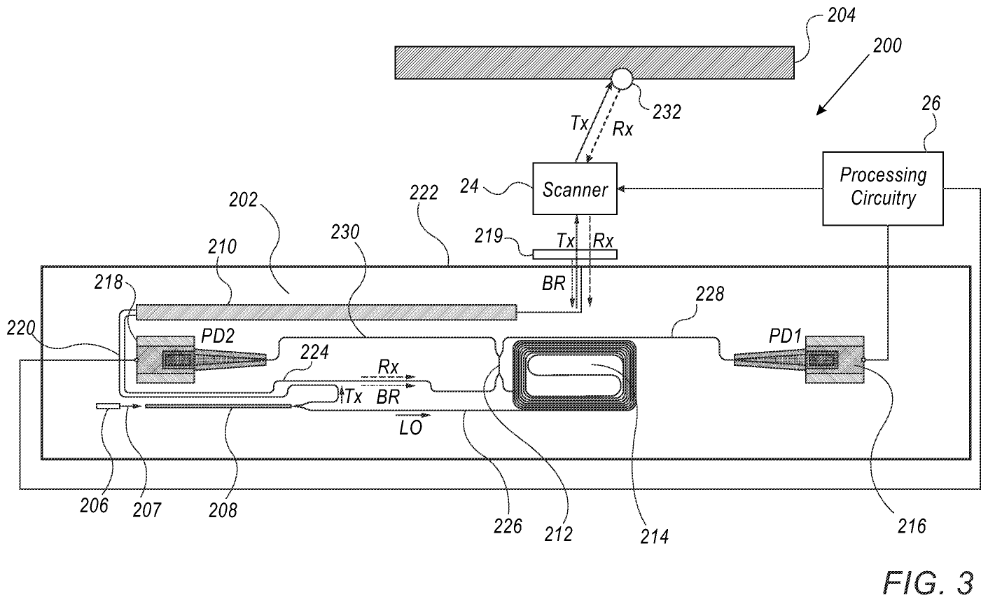

FIG. 1 is a schematic top view of an FMCW LiDAR system in accordance with an embodiment of the invention. FMCW LiDAR system 20 comprises an optoelectronic assembly 22, a scanner 24, and processing circuitry 26. System 20 measures the range of a target, such as a target 28, and possibly the target velocity, as well. Optoelectronic assembly 22 in the present embodiment comprises discrete, free-space optical components, including a modulated light source 30, which serves as the optical transmitter, beamsplitters 32, 34, and 36, an optical delay line 38, a reflector 40, and a balanced photodetector (BPD) 42. (Alternatively or additionally, optoelectronic assembly 22 may comprise a PIC, for example as shown in FIG. 3.) Scanner 24 comprises, for example, a high-speed MEMS mirror or a rotating polygon mirror (not shown) for scanning a Tx beam emitted by optoelectronic assembly 22.

Processing circuitry 26 controls the operation of scanner 24 (and possibly other system components) and acquires the electrical signals output by BPD 42. Processing circuitry 26 typically comprises analog and digital signal processing components for extracting and measuring the frequency of the beat signal generated by system 20. Additionally or alternatively, at least some of the functions of processing circuitry 26 may be carried out in software, for example by a programmable microprocessor or microcontroller.

Light source 30 emits a beam 31 of frequency-modulated coherent radiation at a wavelength λ, with the beam divided by beamsplitter 32 into an LO beam and a Tx beam. The Tx beam passes through beamsplitter 34 and exits optoelectronic assembly 22 toward scanner 24, which directs the beam to a point 44 on target 28. A reflected beam Rx returns from point 44 to scanner 24 and to beamsplitter 34. The Rx beam is reflected by beamsplitter 34, reflector 40, and beamsplitter 36 into BPD 42. The LO beam continues from beamsplitter 32 into optical delay line 38, which has an optical pathlength of OP_{DL}.

The term “optical length” (also referred to as “optical pathlength” or simply “pathlength”) experienced by a propagating beam refers to the geometrical length L of the path of the beam multiplied by the effective refractive index n of the material in the path at the wavelength of the beam. For a beam propagating through several optical components, possibly including free space, the optical pathlength is a sum of the length of the path in each component multiplied by the effective refractive index of the respective component.

Exiting from optical delay line 38, the LO beam passes through beamsplitter 36 into BPD 42, where it is mixed with the Rx beam. The mixing of the Rx beam and LO beam in BPD 42 produces a beat signal with a beat frequency of f_{BEAT}. Processing circuitry 26 extracts f_{BEAT} from the beat signal and processes it to find the range and velocity of point 44 on target 28. By scanning the Tx beam over multiple points on target 28, the range and velocity of each of these points may be determined.

The extraction of the beat frequency f_{BEAT} is potentially confounded by the presence of a back reflection beam BR. In the pictured example, the BR beam is generated by a reflection of the Tx beam from a face 46 of beamsplitter 34, but back reflections may alternatively be scattered from other optical elements in system 20. The BR beam propagates together with the Rx beam from beamsplitter 34 through reflector 40 and beamsplitter 36 to BPD 42, and mixes with the LO beam and the Rx beam. This mixture of the LO and BR beams gives rise to a beat frequency f_{BEAT,BR}. Although f_{BEAT,BR} is typically much lower frequency than f_{BEAT}, the strong, low-frequency beat adds phase noise in the output of BPD 42 and thus degrades the accuracy of measurement of f_{BEAT}.

To suppress the phase noise, optical delay line 38 is used to reduce the optical path difference between the LO beam and the BR beam, OPD_{LO-BR} to be either 0 or λ/2. The optical path difference OPD_{LO-BR} is the difference between the optical path of the LO beam, from the beamsplitting surface of beamsplitter 32 through optical delay line 38 to the beamsplitting surface of beamsplitter 36, and the optical path of the BR beam, from the beamsplitting surface of beamsplitter 32 to face 46 (along the Tx beam) and further along the BR beam to the beamsplitting surface of beamsplitter 34, reflector 40, and to the beamsplitting surface of beamsplitter 36. (Possible phase shifts of the beams at the various surfaces along these two paths are included in the respective optical paths.)

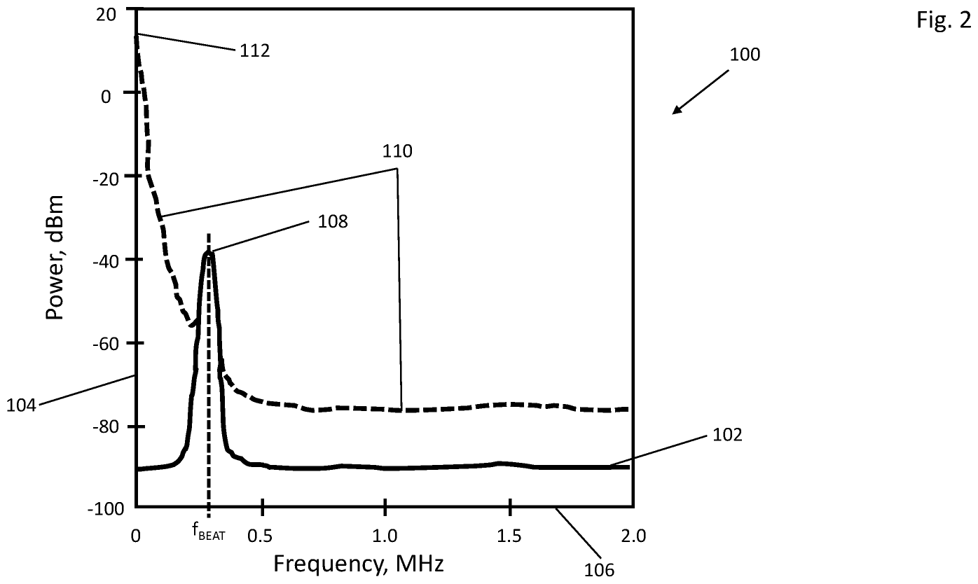

FIG. 2 is a graph 100 that schematically illustrates simulated beat signal spectra in system 20 for different levels of power of the BR beam, in accordance with an embodiment of the invention. The signals in graph 100 are shown on a logarithmic ordinate axis 104, with signal power from −100 dBm to +20 dBm, against a linear abscissa axis 106, with frequency from 0 to 2.0 MHz.

A curve 102 in FIG. 2 shows the beat signal obtained from mixing the LO beam and the Rx beam assuming target 28 to be at a range of 20 cm. Curve 102 contains a peak 108 at the beat frequency f_{BEAT}, which is low (about 0.3 MHz in this example) because of the short distance to the target. Curve 102 is computed assuming the BR beam power to be zero. In this case the phase noise of the beat signal (a measure of inaccuracy of the frequency measurement) is less than the shot noise.

A curve 110 displays the beat signal with the added effect of a BR beam with a power of −30 dB relative to the Tx beam and an optical pathlength of the BR beam (OP_{BR}) of mm. Optical delay line 38 has been adjusted so that the optical path difference OPD_{LO-BR} equals to 0. In the immediate vicinity of peak 108, curve 110 closely follows curve 102. However, due to the zero path difference OPD_{LO-BR}, curve 110 still has a strong peak 112 at zero frequency (DC), with a pronounced noise level around peak 108, thus lowering the SNR of the beat signal and reducing the accuracy of the measurement of the beat frequency. For longer ranges of target 28 (with higher beat frequencies f_{BEAT}), the effect of the noise due to the BR beam is reduced.

Adjusting optical delay line 38 so that OPD_{LO-BR} equals λ/2 causes the LO and the BR beams to mix in opposite phases, so that a portion of the LO beam cancels the BR beam. Thus, mixing of the LO and BR beams at BPD 42 would produce a zero signal, and the beat signal would be again displayed by curve 102, with improved accuracy of the measurement.

FIG. 3 is a schematic top view of an FMCW LiDAR system 200, in accordance with an alternative embodiment of the invention. System 200 comprises a PIC 202, along with scanner 24 and processing circuitry 26, and measures the range of a target, such as a target 204.

PIC 202 is implemented on a planar substrate, such as a silicon-on-insulator (SOI) wafer, and comprises a light source 206, a splitter 208, a discriminator 210, a mixer 212, an optical delay line 214 (with an optical pathlength of OP_{DL}), and a balanced pair of photodiodes 216 and 218. Light source 206 may be either a source integrated into PIC 202 or an external source and outputs modulated, polarized coherent optical radiation. Splitter 208 comprises a silicon Y-branch splitter. Discriminator 210 in the present example comprises a polarization splitter and rotator, which operates in conjunction with a quarter-wave plate 219 to separate the incoming Rx beam from the outgoing Tx beam. Mixer 212 comprises a 50:50 directional coupler. Photodiodes 216 are fabricated, for example, using epitaxial growth of germanium on silicon.

The optical components of PIC 202 are interconnected by waveguides that are deposited and etched on the substrate. A transmit waveguide 220 couples splitter 208 via discriminator 210 to an edge 222 of PIC 202 from which the Tx beam is emitted, and a receive waveguide 224 couples the Rx beam from the edge of the PIC to mixer 212 via the discriminator. A local waveguide 226 couples splitter 208 to optical delay line 214 and further to mixer 212. Detector waveguides 228 and 230 couple the output of mixer 212 to photodiodes 216 and 218, respectively.

Waveguides 220, 224, 226, 228, and 230, as well as optical delay line 214, typically comprise a semiconductor core, such as Si or SiN, with dielectric cladding, such as SiO₂. The optical pathlength of delay line 214, used for adjusting the optical pathlength difference between receive waveguide 224 and local waveguide 226, is controlled by an appropriate choice of the dimensions of the core and cladding.

Splitter 208 divides the radiation output by light source 206 into an LO beam and a Tx beam. The Tx beam passes along transmit waveguide 220 through discriminator 210 and exits PIC 202 through edge 222 toward scanner 24, which directs the beam to a point 232 on target 204.

The reflected Rx beam returns via scanner 24 to PIC 202. In PIC 202, the Rx beam is guided by receive waveguide 224 to mixer 212. The LO beam continues from splitter 208 along local waveguide 226 into optical delay line 214 and further to mixer 212. In mixer 212, the LO beam is mixed with the Rx beam, and the mixed beams propagate along respective waveguides 228 and 230 to photodiodes 216 and 218. As in device 20, the mixing of the Rx beam and LO beam produces a beat signal in photodiodes 216 and 218 with a beat frequency of f_{BEAT}. Processing circuitry 26 extracts f_{BEAT} from the beat signal and processes it to find the range and velocity of point 232 on target 204. By scanning the Tx beam over multiple points on target 204, the range and velocity of each of these points may be determined.

Due to the mismatch between the refractive indices of silicon and air at edge 222, a significant portion of the Tx beam impinging on the edge may be scattered or reflected back as a BR beam, which propagates together with the Rx beam to mixer 212, thus increasing the phase noise in the beat signal as explained above. The phase noise is mitigated in system 200 by selecting the optical pathlength OP_{DL} of optical delay line 214 so that the optical path difference OPD_{LO-BR} between the LO beam and the BR beam is either zero or λ/2. Because optical delay line 214 is fabricated on PIC 202 together with the other system components, any variations of optical parameters due to temperature fluctuations will affect all the waveguide structures of the PIC simultaneously, thus eliminating any fluctuations in the optical path difference OPD_{LO-BR}.

Process variations during the fabrication of PIC 202 may affect the nominal value of the optical path difference OPD_{LO-BR}. Any deviation of OPD_{LO-BR} from its desired value (either zero or λ/2) may be corrected locally, after fabrication of PIC 202, by adjusting the optical properties of optical delay line 214 and/or other waveguides. These adjustments may be made, for example, by changing the refractive index of the waveguide material and the cladding material and/or slightly changing the waveguide length using, for example, strain, pressure, temperature, or light.

If required, active phase shifters available for PIC platforms, such as thermal phase shifters, carrier-injection phase shifters, or electro-optical phase shifters, may be employed for actively and continuously tuning the optical path difference OPD_{LO-BR}, possibly using closed-loop feedback.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An optical sensing device, comprising:
an optical transmitter, coupled to transmit outgoing modulated radiation from a coherent radiation source at a predefined wavelength toward a target;
a splitter coupled to split off a fraction of the outgoing modulated radiation;
an optical element disposed in a path of the outgoing modulated radiation following the splitter;
a mixer which is coupled to mix the fraction of the outgoing modulated radiation with incoming radiation, including the modulated radiation that has been reflected from the target via the optical element;
an optical delay line, configured to convey the fraction of the outgoing modulated radiation from the splitter to the mixer over a first optical length that is within one wave, at the predefined wavelength, of a second optical length from the splitter to the mixer of a portion of the modulated radiation that is scattered from the optical element into the mixer; and
a photodetector coupled to receive the mixed radiation from the mixer.

2. The device according to claim 1, wherein the first optical length differs from the second optical length by one half wave at the predefined wavelength.

3. The device according to claim 1, wherein the first optical length is equal to the second optical length at the predefined wavelength.

4. The device according to claim 1, wherein the optical transmitter comprises a transmit waveguide coupled between the splitter and the optical element, and wherein the device comprises a receive waveguide, which is coupled to convey the incoming radiation from the optical element to the mixer, and wherein the optical delay line comprises a local waveguide coupled between the splitter and the mixer.

5. The device according to claim 4, and comprising a planar substrate, wherein the transmit waveguide, the receive waveguide, and the local waveguide are disposed on the planar substrate in a photonic integrated circuit (PIC).

6. The device according to claim 5, wherein the local waveguide comprises a semiconductor core and a cladding, having respective dimensions chosen so as to set the first optical length.

7. The device according to claim 1, wherein the optical delay line is tunable so as to adjust the first optical length relative to the second optical length.

8. The device according to claim 1, wherein the photodetector is configured to output a beat signal responsively to an instantaneous frequency difference between the outgoing modulated radiation and the incoming radiation received via the optical element.

9. The device according to claim 8, wherein the photodetector comprises a balanced pair of photodiodes.

10. The device according to claim 8, and comprising processing circuitry, which is configured to find a range and velocity of the target responsively to the beat signal.

11. A method for optical sensing, comprising:
transmitting outgoing modulated radiation from a coherent radiation source at a predefined wavelength toward a target via an optical element;
splitting off a fraction of the outgoing modulated radiation at a location in a path of the outgoing modulated radiation between the coherent radiation source and the optical element;
conveying the fraction of the outgoing modulated radiation from the location of the splitting to a mixer via an optical delay line over a first optical length that is within one wave, at the predefined wavelength, of a second optical length from the location to the mixer of a portion of the modulated radiation that is scattered from the optical element into the mixer;
in the mixer, mixing the fraction of the outgoing modulated radiation with incoming radiation, including the modulated radiation that has been reflected from the target via the optical element; and
detecting the mixed radiation.

12. The method according to claim 11, wherein the first optical length differs from the second optical length by one half wave at the predefined wavelength.

13. The method according to claim 11, wherein the first optical length is equal to the second optical length at the predefined wavelength.

14. The method according to claim 11, wherein the outgoing modulated radiation is transmitted through a transmit waveguide between the location of the splitting and the optical element, and wherein the incoming radiation is conveyed via a receive waveguide from the optical element to the mixer, and wherein the optical delay line comprises a local waveguide coupled between the location of the splitting and the mixer.

15. The method according to claim 14, wherein the transmit waveguide, the receive waveguide, and the local waveguide are disposed on a planar substrate of a photonic integrated circuit (PIC).

16. The method according to claim 15, wherein the local waveguide comprises a semiconductor core and a cladding, having respective dimensions chosen so as to set the first optical length.

17. The method according to claim 11, and comprising tuning the optical delay line so as to adjust the first optical length relative to the second optical length.

18. The method according to claim 11, wherein detecting the mixed radiation comprises outputting a beat signal responsively to an instantaneous frequency difference between the outgoing modulated radiation and the incoming radiation received via the optical element.

19. The method according to claim 18, wherein the mixed radiation is detected by a balanced pair of photodiodes, which outputs the beat signal.

20. The method according to claim 18, and comprising processing the beat signal to find a range and velocity of the target.
